(19) United States
(12) Patent Application Publication
(10) Pub. No.: US 2015/0107994 A1
(43) Pub. Date: Apr. 23, 2015

(54) BIOSENSOR

(71) Applicant: Samsung Electronics Co., Ltd., Gyeonggi-do (KR)

(72) Inventors: Chul-Ho CHO, Gyeonggi-do (KR); Seong-Je CHO, Gyeonggi-do (KR); Jae-Geol CHO, Gyeonggi-do (KR); Sun-Tae JUNG, Gyeonggi-do (KR)

(73) Assignee: Samsung Electronics Co., Ltd.

(21) Appl. No.: 14/518,439

(22) Filed: Oct. 20, 2014

(30) Foreign Application Priority Data
Oct. 22, 2013 (KR) 10-2013-0126088

(51) Int. Cl. G01N 27/327; G01N 27/403

(52) U.S. Cl. CPC G01N 27/3272; G01N 27/403
USPC 204/403.14

(57) ABSTRACT

A biosensor is provided. The biosensor includes a lower substrate including an electrode unit, an insulation layer disposed on the lower substrate, a first spacer layer disposed on the insulation layer over the electrode unit, an enzyme unit disposed on the first spacer layer, a second spacer layer disposed on the enzyme unit, such that the enzyme unit is interposed between the first and second spacer layers, and an upper substrate disposed on the second spacer layer. The electrode unit includes a working electrode, and a reference electrode and a counter electrode that surround a periphery of the working electrode, facing the working electrode.

### PRIORITY

This application claims priority under 35 U.S.C. §119(a) to a Korean Patent Application filed in the Korean Intellectual Property Office on Oct. 22, 2013 and assigned Serial No. 10-2013-0126088, the entire content of which is incorporated herein by reference.

### BACKGROUND

1. Field of the Invention

The present invention relates generally to a biosensor, and more specifically, to a biosensor for use in measuring blood sugar.

2. Description of the Related Art

Many sensors used for measurement and analysis in a test requiring a liquid sample for clinical or environment monitoring have a small sample capacity. In such sensors, it is important for a small-capacity sample to accurately reach a part of the sensor in which reaction of a measurer component of the sensor takes place.

For example, an amount of glucose in a blood sample (i.e., blood sugar) can be periodically measured to diagnose and prevent diabetes, by using a blood sugar meter. A blood sugar meter measures a glucose level using an electrical signal resulting from an electrochemical reaction between a chemical material inside a biosensor (e.g., a blood sugar strip) and a sample taken from a patient by means of the biosensor.

The biosensor of the blood sugar meter is produced by forming an electrode system including a plurality of electrodes on an electrically insulating substrate by screen printing (or other similar processes), and subsequently forming an enzyme reaction layer including a hydrophilic polymer, an oxidoreductase, and an electron acceptor on this electrode system.

When a sample containing glucose is introduced to the enzyme reaction layer through a sample inlet of the biosensor, the enzyme reaction layer dissolves the sample, which triggers reaction of the enzyme of the sample. As a result, the glucose is oxidized and the electron acceptor is reduced.

Upon completion of this enzyme reaction, the reduced electron acceptor is oxidized electrochemically. Based on a current value of oxidation measured during the oxidization, the concentration of the glucose contained in the sample can be quantitated.

This biosensor needs a sufficient amount of the sample in order to trigger a sensor reaction. Further, the sample must be filled accurately in a predetermined area. For this purpose, most of biosensors include a narrow fluid path to induce a capillary phenomenon.

The biosensor includes a lower substrate with a working electrode, a reference electrode, and a counter electrode (or auxiliary counter), a middle substrate with a sample inlet, and an upper substrate. Overall, the biosensor is formed three-dimensionally into a rectangular polygon shaped like “I” or “—”. A user injects a sample in the sample inlet provided at an end of the biosensor, thus inducing flow of the sample into the biosensor.

Specifically, the working electrode has a reaction sample and detects the amount of reaction current, and the reference electrode and the counter electrode measure the resistance of the reaction sample.

The working electrode measures the glucose level of the reaction sample based on the detected current amount.

However, because the working electrode, the reference electrode, and the counter electrode are arranged on the lower substrate with the reference electrode facing one surface of the working electrode (i.e., too small of an area of the working electrode in the conventional biosensor), it is difficult to derive a sufficient amount of reaction current.

Since only one surface of the working electrode faces the reference electrode, the resulting difficulty in deriving a sufficient amount of reaction current leads to a decreased blood sugar measurement sensitivity of the biosensor. As a consequence, the reliability of the product is decreased.

With the reference electrode facing only one surface of the working electrode, an alignment error occurs between the electrodes and parts in the fabrication process of the biosensor, thereby decreasing the assembly accuracy of the product,

The above information is presented as background information only to assist with an understanding of the present invention. No determination has been made, and no assertion is made, as to whether any of the above might be applicable as prior art with regard to the present invention.

### SUMMARY OF THE INVENTION

Accordingly, the present invention has been made to address at least the above-mentioned problems and/or disadvantages and to provide at least the advantages described below.

Accordingly, an aspect of the present invention is to provide a biosensor in which a reference electrode and an counter electrode surround a working electrode, facing a plurality of surfaces of the working electrode, so as to derive a sufficient amount of current in the working electrode, increase a product reliability, prevent an alignment error of parts which occurs in the prior art when single-surface facing electrodes of a biosensor are assembled with the parts, and increase the assembly accuracy of the product.

Another aspect of the present invention is to provide a biosensor in which a reference electrode and an counter electrode are configured along various shapes available to a working electrode, facing a plurality of surfaces of the working electrode, so as to increase the number of surfaces of the working electrode facing the reference and counter electrodes, to increase the amount of reaction current derived in the working electrode, and thus to increase the measurement sensitivity of blood sugar in the product.

In accordance with an aspect of the present invention, there is provided a biosensor. The biosensor includes a lower substrate including an electrode unit, an insulation layer disposed on the lower substrate, a first spacer layer disposed on the insulation layer over the electrode unit, an enzyme unit disposed on the first spacer layer, a second spacer layer disposed on the enzyme unit, such that the enzyme unit is interposed between the first and second spacer layers, and an upper substrate disposed on the second spacer layer. The electrode unit includes a working electrode, and a reference electrode and a counter electrode that surround a periphery of the working electrode, facing the working electrode.

In accordance with another aspect of the present invention, there is provided a biosensor. The biosensor includes a lower substrate including an electrode unit, an insulation layer disposed on the lower substrate over the electrode unit, a first spacer layer disposed on the insulation layer, an enzyme unit disposed on the first spacer layer, a second spacer layer disposed on the enzyme unit, such that the enzyme unit is interposed between the first and second spacer layers, and an upper substrate disposed on the second spacer layer. The electrode unit includes a working electrode, and a reference electrode and a counter electrode that are provided along a shape of the working electrode, facing the working electrode.

### BRIEF DESCRIPTION OF THE DRAWINGS

The above and other aspects, features and advantages of certain embodiments of the present invention will be more apparent from the following description taken in conjunction with the accompanying drawings, in which:

FIG. 1 is diagram illustrating an exploded perspective view of a biosensor according to an embodiment of the present invention;

FIG. 2 is diagram illustrating a plan view of a lower substrate in the biosensor according to the embodiment of the present invention;

FIG. 3 is diagram illustrating an enlarged plan view of a part A illustrated in FIG. 2;

FIG. 4 is diagram illustrating a plan view of the lower substrate combined with an insulation layer in the biosensor according to an embodiment of the present invention;

FIG. 5 is diagram illustrating an exploded perspective view of a biosensor according to another embodiment of the present invention;

FIG. 6 is diagram illustrating a plan view of a lower substrate in the biosensor according to the embodiment of FIG. 5;

FIG. 7 is diagram illustrating an enlarged plan view of a part B illustrated in FIG. 6; and

FIG. 8 is a graph illustrating glucose concentrations versus reaction current values in the biosensors according to embodiments of the present invention.

### DETAILED DESCRIPTION OF EMBODIMENTS OF THE PRESENT INVENTION

The following description with reference to the accompanying drawings is provided to assist in a comprehensive understanding of embodiments of the present invention as defined by the claims and their equivalents. The description includes various specific details to assist in that understanding, but these are to be regarded as mere examples. Accordingly, those of ordinary skilled in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the dictionary meanings, but, are merely used to enable a clear and consistent understanding of embodiments of the present invention.

Herein, the singular forms “a,” “an,” and “the” include plural referents, unless the context clearly dictates otherwise. Thus, for example, reference to “a component surface” includes reference to one or more of such surfaces.

Herein, the term “substantially” is used when the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Throughout the drawings, like reference numerals may be used to refer to the same or similar parts, components, and structures.

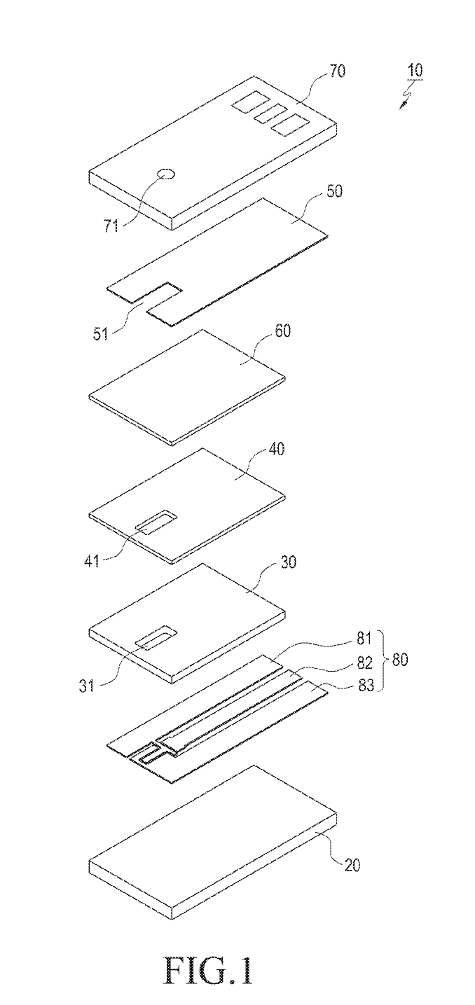

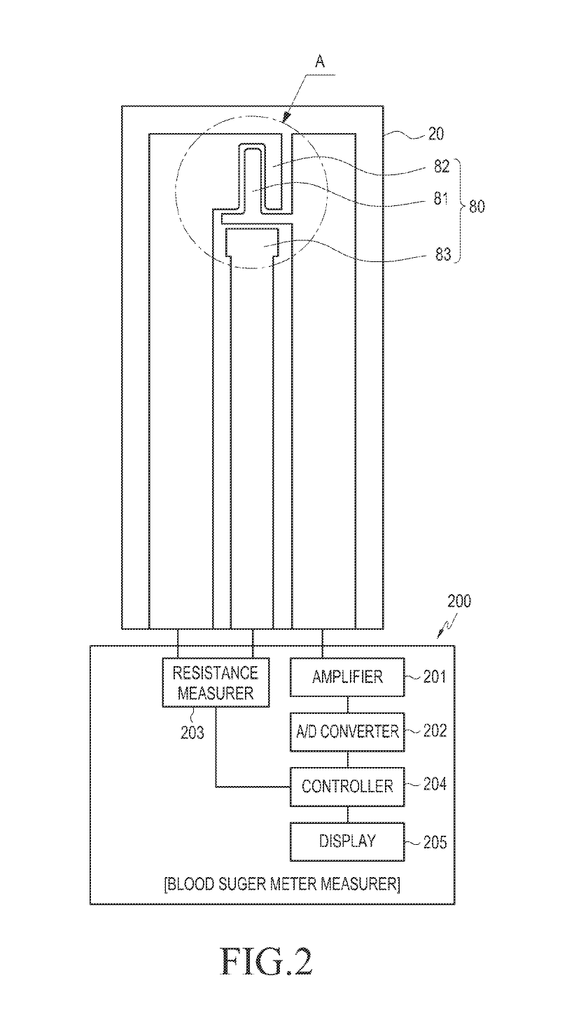

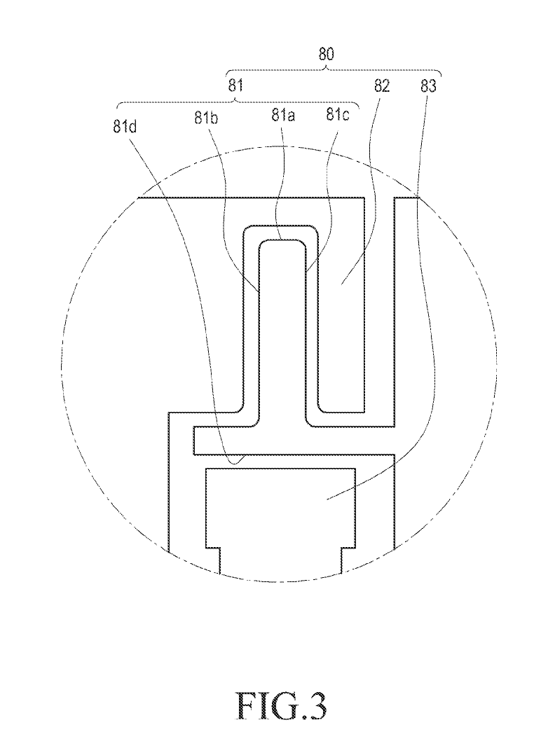

FIG. 1 is a diagram illustrating an exploded perspective view of a biosensor 10 according to an embodiment of the present invention, FIG. 2 is a diagram illustrating a plan view of a lower substrate 20 in the biosensor 10 according to the embodiment of the present invention, and FIG. 3 is a diagram illustrating an enlarged plan view of a part A illustrated in FIG. 2.

With reference to FIGS. 1, 2, and 3, the structure of the biosensor 10 is described as follows. The biosensor 10 includes the lower substrate 20, an insulation layer 30, first and second spacer layers 40 and 50, an enzyme unit 60, and an upper substrate 70. The lower substrate 20 is provided with an electrode unit 80. The insulation layer 30 is disposed on the lower substrate 20 over the electrode unit 80 to electrically isolate the electrode unit 80. The first spacer layer 40 is disposed on the insulation layer 30 with the enzyme unit 60 containing materials electrochemically reacting with a sample (not shown) disposed on the first spacer layer 40 interposed between the first and second spacer layers 40 and 50. The upper substrate 70 includes an air outlet hole 71 for enabling the introduced sample to move and is disposed on the second spacer layer 50. Sample inlets 31, 41, and 51 are formed respectively on the insulation layer 30, the first spacer layer 40, and the second spacer layer 50.

As illustrated in FIGS. 2 and 3, the electrode unit 80 includes a working electrode 81, a reference electrode 82, and a counter electrode (i.e., an auxiliary electrode) 83. The working electrode 81 faces the reference electrode 82 and the counter electrode 83. More specifically, the reference electrode 82 and the counter electrode 83 surround all of the peripheral surfaces of the working electrode 81, while facing the working electrode 81.

As shown in FIG. 3, the reference electrode 82 faces first, second, and third surfaces 81a, 81b, and 81c of the working electrode 81, and the counter electrode 83 faces a fourth surface 81 d of the working electrode 81. Therefore, as the reference and counter electrodes 82 and 83 face multiple surfaces of the working electrode 81, the working electrode 81 is able to derive a sufficient amount of current to increase the blood sugar measurement sensitivity of the product.

More specifically, the first, second, third, and fourths surfaces 81a, 81b, 81c, and 81d may be front, left side, right side, and rear surfaces of the working electrode 81, respectively as described above with reference to FIG. 3. In other words, the reference electrode 82 and the counter electrode 83 surround the whole peripheral surfaces of the working electrode 81.

As the reference electrode 82 and the counter electrode 83 are formed around the periphery of the working electrode 81, an alignment error between the sample inlet 31 of the insulation layer 30 and the electrodes 81, 82, and 83 is decreased during assembly, thus increasing the assembly accuracy of the biosensor 10.

The insulation layer 30 is assembled on the electrodes 81, 82, and 83 arranged as described above. Herein, the sample inlet 31 of the insulation layer 30 is combined in the state where the electrodes 81, 82, and 83 are arranged. In other words, even though the sample inlet 31 of the insulation layer 30 moves slightly, the electrodes 81, 82, and 83 may be maintained as arranged.

Therefore, an alignment error between the electrodes 81, 82, and 83 and the insulation layer 30 is reduced during assembly in a fabrication process of the biosensor 10.

As illustrated in FIG. 3, the working electrode 81 may be shaped like “I” and the reference electrode 82 may be shaped like “U” according to an embodiment of the present invention. However, other shapes may be used in accordance with embodiments of the present invention. More specifically, there are many possible modified embodiments in which the reference electrode 82 is configured to surround the working electrode 81.

The electrodes 81, 82, and 83 may be formed of any of epoxy, palladium, copper, gold, platinum, iridium, silver/silver chloride, carbon, and other such materials in accordance with embodiments of the present invention. However, these materials are merely listed as examples, and the electrodes 81, 82, and 83 may be formed of other materials in accordance with embodiments of the present invention.

The electrodes 81, 82, and 83 may be attached onto the lower substrate 20 by using one of screen printing, vacuum deposition, etching, a conductive tape, or other such processes.

The upper and lower substrates 70 and 20 may be formed of any of ceramic, a glass film, and a polymer material in an embodiment of the present invention. However, these materials are merely listed as examples, and the upper and lower substrates 70 and 20 may be formed of other materials in accordance with embodiments of the present invention.

With reference to FIG. 1, assembly of the biosensor 10 is described as follows. The working electrode 81 is first placed on a top surface of the lower substrate 20, and then the reference electrode 82 and the counter electrode 83 are arranged to surround the all of the peripheral surfaces of the working electrode 81, while facing the working electrode 81.

The reference electrode 82 surrounds the front, left side, and right side surfaces of the working electrode 81, while the counter electrode 83 surrounds the rear face of the working electrode 81.

In this state, the insulation layer 30 is placed on the lower substrate 20 including the electrode unit 80, and the first and second spacer layers 40 and 50 are stacked on the insulation layer 30, and the enzyme unit 60 containing materials that react with a sample (not shown) is interposed between the first and second spacer layers 40 and 50. Then the upper substrate 70 is stacked on the second spacer layer 50.

When the lower substrate 20, the insulation layer 30, and the first and second spacer layers 40 and 50 are assembled, the sample inlets 31, 41, and 51 are placed over the electrode unit 80 with the sample inlet 31 of the insulation layer 30 aligned with the sample inlets 41 and 51 of the first spacer layer 40 and the second spacer layer 50.

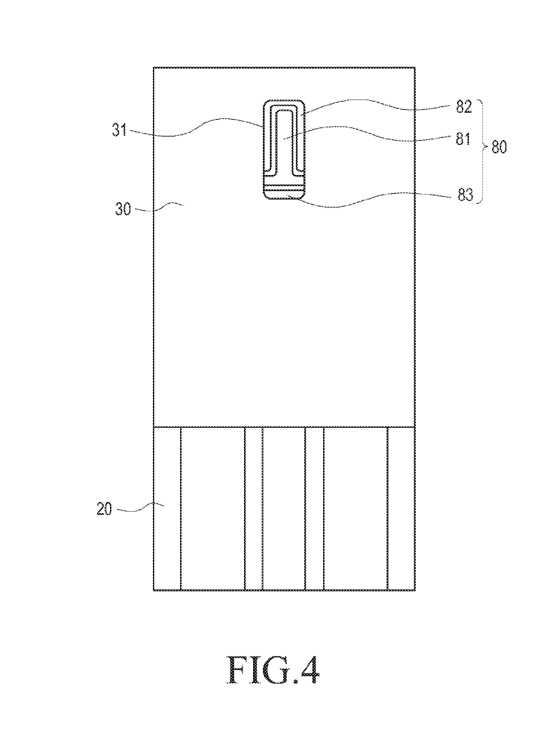

FIG. 4 is diagram illustrating a plan view of the lower substrate combined with an insulation layer in the biosensor according to an embodiment of the present invention.

As illustrated in FIG. 4, the sample inlets 31, 41, and 51 are aligned with one another so that the reference electrode 82 surrounds the front, left side, and right side surfaces of the working electrode 81 and the counter electrode 83 faces the rear surface of the working electrode 81 in the sample inlets 31, 41, and 51.

Operation of the biosensor 10 in this state are described as follows.

As illustrated in FIG. 4, a sample (not shown) is introduced in the sample inlets 31, 41, and 51 of the biosensor 10 of the present invention.

According to certain embodiments of the present invention, a sample amount ranging from 0.1 to 2.0 μl, such as 0.1 to 1.0 μl, or 0.3 to 0.7 μl may be used.

If the amount of the sample is less than a certain amount, such as 0.1 μl, an accurate measurement is not guaranteed due to the too small amount of the sample. If the amount of the sample is larger than a certain amount, such as 3.0 μl, there will be too much of the sample, causing problems.

Accordingly, the amount of the sample is most preferably 0.3 to 0.7 μl. The sample flows through the sample inlets 31, 41, and 51, moving to the enzyme unit 60 between the first and second spacer layers 40 and 50.

The air outlet hole 71 formed on the upper substrate 70 discharges air so enable the sample to be transferred to the sample inlets 31, 41, and 51 as well as in an air discharge direction.

As the sample is introduced into the enzyme unit 60 as well as the sample inlets 31, 41, and 51, the materials (not shown) of the enzyme unit 60 electrochemically react with the sample.

As shown in FIG. 2, When the electrochemical reaction takes place in the enzyme unit 60 of the biosensor 10, a blood sugar meter (not shown) receives electrical signals from the working electrode 81, the reference electrode 82, and the counter electrode 83 of the lower substrate 20, measures a glucose level based on the received electrical signals, and displays the measured glucose level on a display 205.

More specifically, when power is supplied to the working electrode 81, an amplifier 201 of the blood sugar meter detects the amount of current flowing in the working electrode 81 and outputs the current amount as a voltage value.

An Analog to Digital (A/D) converter 202 of the blood sugar meter converts the analog voltage value received from the amplifier 201 to a digital signal and transmits the digital signal to a controller 204.

A resistance measurer 203 of the blood sugar meter measures 200 a resistance value between the counter electrode 83 and the reference electrode 82 and transmits the resistance value to the controller 204.

Specifically, the reference electrode 82 and the counter electrode 83 measure the resistance of the sample introduced through the sample inlets 31, 41, and 51.

The working electrode 81 detects the amount of a reaction current and measures the glucose level of the sample based on the amount of the reaction current.

More specifically, after the sample is introduced, the resistance between the reference electrode 82 and the counter electrode 83 is measured and a time from the moment of detecting the amount of the reaction current in the working electrode 81 until the moment of sensing a change in the resistance between the reference electrode 82 and the counter electrode 83 is counted. Then a determination of whether the sample introduction has an error is performed based on the count. Herein, the amount of the reaction current in the working electrode 81 is detected and the glucose level of the sample is measured based on the amount of the reaction current. In this state, the measured glucose level is corrected according to the measurement of the resistance between the reference electrode 82 and the counter electrode 83.

The controller 204 controls the overall operation of the blood sugar meter and displays a final measured glucose level on the display 205.

As described above, since the reference electrode 82 and the counter electrode 83 surround the peripheral surfaces of the working electrode 81, the working electrode 81 derives a sufficient amount of a reaction current from the sample introduced through the sample inlets 31, 41, and 51 and the reference electrode 82 and the counter electrode 83 measure a resistance of the sample. As a consequence, the blood sugar measurement sensitivity of the biosensor 10 is increased.

Further, the working electrode 81 introduces a reaction current of the introduced sample and the reference electrode 82 enables the working electrode 81 to fast reach a normal state through quick reduction of the working electrode 81. Accordingly, according to certain embodiments of the present invention, the reference electrode 82 and the counter electrode 83 surround the peripheral surfaces of the working electrode 81.

After the working electrode 81 measures the amount of the reaction current of the sample, the reference electrode 82 and the counter electrode 83 enable the working electrode 81 to fast reach the normal state through fast reduction of the working electrode 81. Therefore, the measurement time of the product may be reduced.

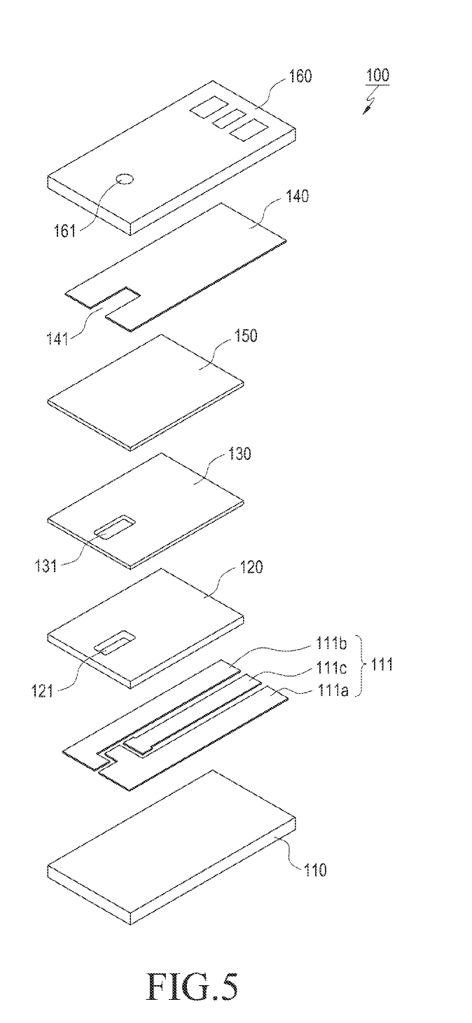

With reference to FIGS. 5, 6, and 7, a biosensor according to another embodiment of the present invention is described as follows. The following description focuses on the differences between the biosensor of FIGS. 5-7 and the biosensor according to an embodiment described with reference to FIGS. 1-4, in order to avoid a redundant description.

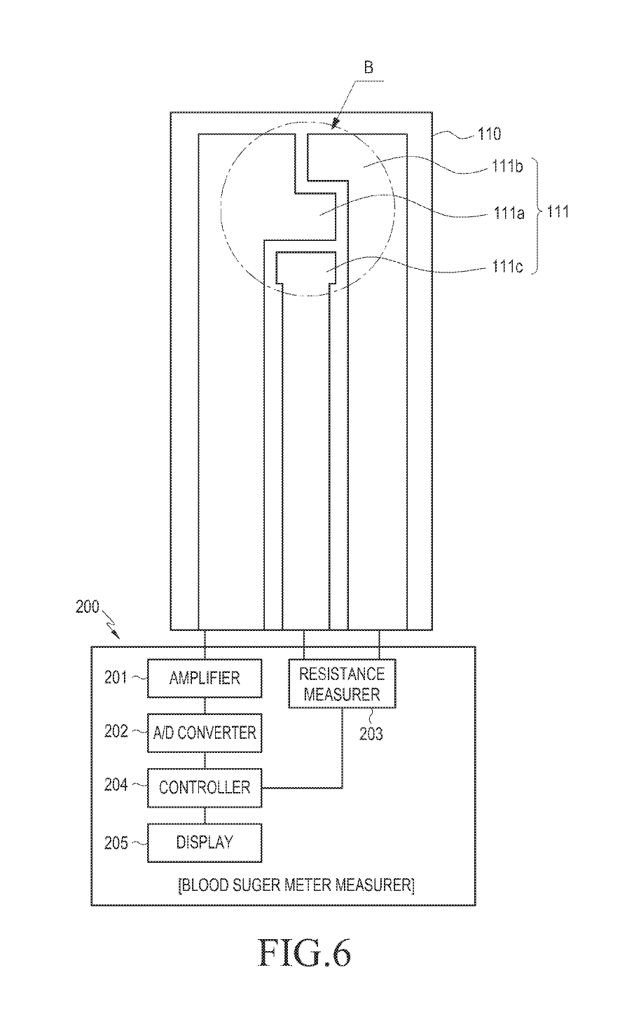

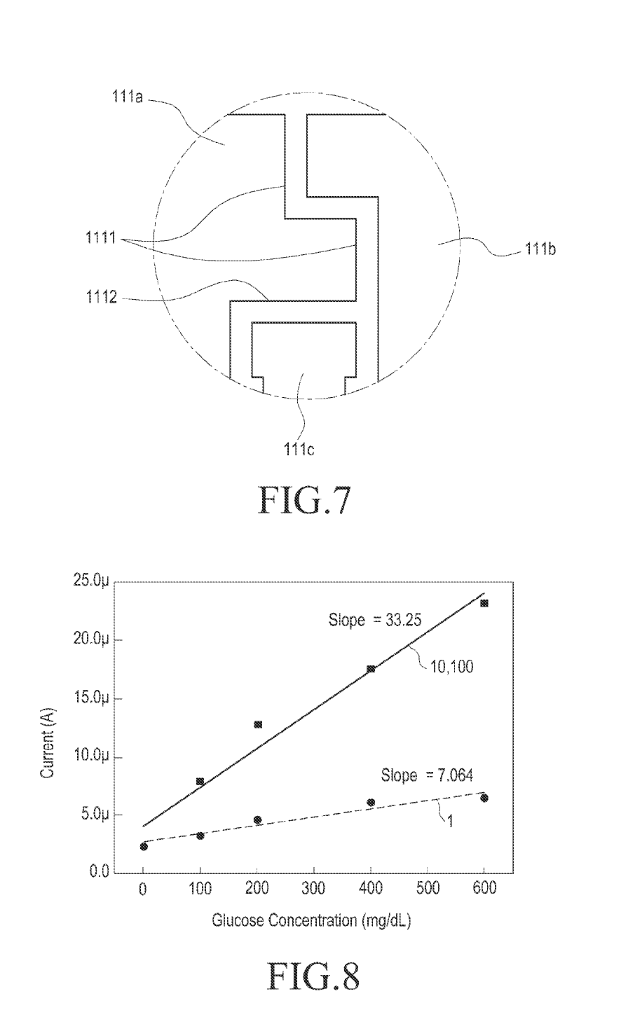

FIG. 5 is a diagram illustrating an exploded perspective view of a biosensor 100 according to another embodiment of the present invention, FIG. 6 is a diagram illustrating a plan view of a lower substrate in the biosensor according to the embodiment of FIG. 5, and FIG. 7 is a diagram illustrating an enlarged plan view of a part B illustrated in FIG. 6.

With reference to FIGS. 5, 6, and 7, a structure of a biosensor according to the another embodiment of the present invention is described as follows. Referring to FIG. 5, the biosensor 100 includes a lower substrate 100 with an electrode unit 111, an insulation later 120, first and second spacer layers 130 and 140, an enzyme unit 150, and an upper substrate 160. The insulation layer 120 is provided on the lower substrate 110 over the electrode unit 111 to electrically insulate the electrode unit 111. The first spacer layer 130 is disposed on the insulation layer 120, with the enzyme unit 150 containing materials electrochemically reacting with a sample (not shown) interposed between the first and second layers 130 and 140. The upper substrate 160 includes an air outlet hole 161 for enabling the introduced sample to move and is disposed on the second spacer layer 140.

The electrode unit 111 includes a working electrode 111a, a reference electrode 111b, and a counter electrode 111c. The working electrode 111a faces the reference electrode 111b and the counter electrode 111c.

As illustrated in FIGS. 6 and 7, the reference electrode 111b and the counter electrode 111c are provided along the shape of the working electrode 111a, facing the working electrode 111a.

More specifically, the reference electrode 111b faces side surfaces 1111 of the working electrode 111a, while the counter electrode 111c faces a lower surface 1112 of the working electrode 111a. As the reference electrode 111b and the counter electrode 111c face multiple surfaces of the working electrode 111a, the working electrode 111a further increases the blood sugar measurement sensitivity of the product by deriving a sufficient amount of a reaction current.

As illustrated in FIG. 7, each of the working electrode 111a and the reference electrode 111b may be shaped into “L” or a lightening symbol according to an embodiment of the present invention. These shapes are merely provided as examples, and do not limit embodiments of the present invention. Many different shapes of the reference electrode 111b and the counter electrode 111c may be formed along the shape of the working electrode 111a, in accordance with embodiments of the present invention.

With reference to FIGS. 5, 6, and 7, an assembly of a biosensor according to the another embodiment of the present invention is described as follows. The working electrode 111a is first placed on a top surface of the lower substrate 110, and then the reference electrode 111b and the counter electrode 111c are arranged along the shape of the working electrode 111a, while facing the working electrode 111a.

The reference electrode 111b faces the side surfaces 1111 of the working electrode 111a, whereas the counter electrode 111c faces the lower surface 1112 of the working electrode 111a.

In this state, the insulation layer 120 is placed on the lower substrate 110 over the electrode unit 111, and the first spacer layer 130 is stacked on the insulation layer 120. Herein, the enzyme unit 150 containing materials that react with a sample (not shown) is interposed between the first and second spacer layers 130 and 140. Then the upper substrate 160 is stacked on the second spacer layer 140.

When the lower substrate 110, the insulation layer 120, and the first and second spacer layers 130 and 140 are assembled, sample inlets 121, 131, and 141 of the insulation layer 120, the first spacer layer 130, and the second spacer layer 140 are placed on the electrode unit 111, while the sample inlet 121 of the insulation layer 120 are aligned with the sample inlets 131 and 141 of the first and second spacers 130 and 140.

More specifically, the sample inlets 121, 131, and 141 are aligned with one another so that the reference electrode 111b faces the side surfaces 1111 of the working electrode 111a and the counter electrode 111c faces the lower surface 1112 of the working electrode 111a in the sample inlets 121, 131, and 141.

In this state, a sample (not shown) is introduced in the sample inlets 121, 131, and 141 of the biosensor 100 according to the embodiment of FIGS. 5-7. The sample flows through the sample inlets 121, 131, and 141, moving to the enzyme unit 150. As the sample is introduced into the enzyme unit 150, materials (not shown) of the enzyme unit 150 electrochemically react with the sample.

As shown in FIG. 6, When the electrochemical reaction takes place in the enzyme unit 150 of the biosensor 100, a blood sugar meter (not shown) receives electrical signals from the working electrode 111a, the reference electrode 111b, and the counter electrode 111c of the lower substrate 110, measures a glucose level based on the received electrical signals, and displays the measured glucose level on a display 205.

The working electrode 111a derives a sufficient amount of a reaction current to increase a measurement sensitivity of the biosensor 100.

The biosensor 100 operates in a similar manner as the biosensor 10 according to the first embodiment of the present invention.

FIG. 8 is a diagram illustrating a graph illustrating reaction current values with respect to glucose concentrations in the biosensors 10 and 100 according to the embodiments FIGS. 1-7.

Referring to FIG. 8, a comparison between the electrode units 80 and 111 of the biosensors 10 and 100 according to the present invention and a conventional biosensor in terms of reaction current values with respect to glucose concentrations reveals that the electrode units 80 and 111 are about 4.7 times more sensitive than an electrode unit of the conventional biosensor.

Since a reference electrode faces only one surface of a working electrode, and thus too small an area of the working electrode in a lower substrate of the conventional biosensor, it is difficult to derive a sufficient amount of a reaction current, thereby decreasing the blood sugar measurement sensitivity of the biosensor.

By contrast, the working electrode and the counter electrode surround the whole peripheral surfaces of the working electrode, facing more surfaces or a larger area of the working electrode according to embodiments of the present invention in order to overcome the above-described problem of the conventional biosensor. Therefore, a working electrode according to embodiments of the present invention is able to derive a sufficient amount of a reaction current from a small amount of a sample and thus increase the blood sugar measurement sensitivity of the product.

Another problem with the conventional electrode unit is an alignment error caused by the reference electrode facing only one surface of the working electrode.

According to embodiments of the present invention, the reference electrode and the counter electrode are arranged so as to surround the whole peripheral surfaces of the working electrode in the electrode unit (e.g., electrode unit 80 in FIG. 2). Therefore, an alignment error may be minimized during assembly between the electrodes and the sample inlet of the insulation layer and the assembly accuracy of the biosensor may be increased.

The biosensors according to various embodiments of the present invention are applicable mainly to a blood sugar meter, to which the present is not limited. Further, the present invention is applicable to various electrochemical test sensors (for example, a portable test device or the like) that take a blood sample and analyze it.

As is apparent from the foregoing description, according to various embodiments of the present invention, since a reference electrode and a counter electrode surround all peripheral surfaces of a working electrode in a lower substrate, facing the multiple surfaces of the working electrode in a biosensor, the working electrode can derive a sufficient amount of a reaction current, the blood sugar measurement sensitivity and reliability of the product are increased, an alignment error between parts is prevented during assembly of an electrode unit and an insulation layer, which might otherwise be caused by one-surface facing between a reference electrode and a working electrode in fabrication of a biosensor, and the assembly accuracy of the product is increased.

Further, as the reference electrode and the counter electrode are configured along various shapes available to the working electrode in the lower substrate, the reference electrode and the counter electrode can face more surfaces of the working electrode. As a consequence, the working electrode can derive a larger amount of a reaction current and the blood sugar measurement sensitivity of the product can further be increased.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A biosensor comprising:
a lower substrate including an electrode unit;
an insulation layer disposed on the lower substrate;
a first spacer layer disposed on the insulation layer over the electrode unit;
an enzyme unit disposed on the first spacer layer;
a second spacer layer disposed on the enzyme unit, such that the enzyme unit is interposed between the first and second spacer layers; and
an upper substrate disposed on the second spacer layer,
wherein the electrode unit comprises:
a working electrode; and
a reference electrode and a counter electrode that surround a periphery of the working electrode, facing the working electrode.

2. The biosensor of claim 1, wherein the reference electrode surrounds first, second, and third surfaces of the working electrode and the counter electrode surrounds a remaining fourth surface of the working electrode.

3. The biosensor of claim 1, wherein the reference electrode and the counter electrode surround whole peripheral surfaces of the working electrode.

4. The biosensor of claim 1, wherein the working electrode is shaped into “I” and the reference electrode is shaped into “U”.

5. The biosensor of claim 1, wherein when the lower substrate, the insulation layer, and the first and second spacer layers are assembled, a sample inlet of the insulation layer is aligned with sample inlets of the first and second spacer layers and the reference electrode and the counter electrode surround whole peripheral surfaces of the working electrode in the sample inlets.

6. The biosensor of claim 1, wherein the electrodes are formed of at least one of epoxy, palladium, copper, gold, platinum, iridium, silver/silver chloride, and carbon.

7. The biosensor of claim 1, wherein the electrodes are attached onto the lower substrate by at least one of screen printing, vacuum deposition, etching, and a conductive tape.

8. The biosensor of claim 1, wherein the upper substrate and the lower substrate are formed of one at least one of ceramic, a glass film, and a polymer material.

9. The biosensor of claim 8, wherein the polymer material includes at least one of polyester, polyvinylchloride, and polycarbonate.

10. A biosensor comprising:
a lower substrate including an electrode unit;
an insulation layer disposed on the lower substrate;
a first spacer layer disposed on the insulation layer over the electrode unit;
an enzyme unit disposed on the first spacer layer;
a second spacer layer disposed on the enzyme unit, such that the enzyme unit is interposed between the first and second spacer layers; and
an upper substrate disposed on the second spacer layer,
wherein the electrode unit comprises:
a working electrode; and
a reference electrode and a counter electrode that are provided along a shape of the working electrode, facing the working electrode.

11. The biosensor of claim 10, wherein each of the working electrode and the reference electrode is shaped into one of “L” and a lightning symbol.

12. The biosensor of claim 10, wherein the reference electrode is provided along a side surface of the working electrode and the counter electrode is provided along a lower surface of the working electrode.
